(19) United States
(12) Patent Application Publication
(10) Pub. No.: US 2012/0226029 A1
(43) Pub. Date: Sep. 6, 2012

(54) LOW Tg LIGNIN

(75) Inventor: Angela P. Dodd, Seattle, WA (US)

(73) Assignee: WEYERHAEUSER NR COMPANY, Federal Way, WA (US)

(21) Appl. No.: 13/218,346

(22) Filed: Aug. 25, 2011

Related U.S. Application Data
(60) Provisional application No. 61/387,372, filed on Sep. 28, 2010.

(51) Int. Cl. C08H 7/00

(52) U.S. Cl. 530/500

(57) ABSTRACT

Lignin has a weight average molecular weight of at least 6,000 daltons and comprising (a) from 2% to 10% of a low molecular component having a weight average molecular weight (M_{W}) of from 300 to 1500 daltons, and (b) from 10% to 50% of a high molecular weight component having a weight average molecular weight (M_{W}) of at least 10,000 daltons; and exhibiting a T_{g} of from 100° C. to 130° C. when measured by differential scanning calorimetry.

### CROSS-REFERENCE TO RELATED APPLICATION

This application is entitled to and claims the benefit of priority under 35 U.S.C. §119 from U.S. Provisional Patent Application Ser. No. 61/387372 filed Sep. 28, 2010, and titled “LOW T_{g} LIGNIN,” the contents of which are incorporated herein by reference.

This application relates to lignin having a low T_{g}.

### BACKGROUND

Lignin is one of the main constituents of woody material. There is not one definite formula for lignin. There are many suggested formulas. The molecule is made up of a number of subgroups which are combined in different ways depending on the type of wood or grass in which the lignin exists. It has been suggested that the building blocks for lignins are the monolignols, coniferyl alcohol, sinaply alcohol and paracoumaryl alcohol. Casey, Pulp and Paper 2^{nd} edition suggests the building blocks to be propyl guaiacyl and propyl syringyl, and the principal building block to be n-propyl benzene. Other building blocks have been suggested.

There is a difference in the formation of lignin depending upon the type of wood or grass from which the lignin is taken. The many building blocks will be combined differently. Different woods or grasses will have different building blocks. Casey suggests the hardwoods have both propyl guaiacyl and propyl syringyl building blocks while softwoods have almost entirely propyl guaiacyl building blocks.

The starting black liquor can be from soda, sulfite or sulfate (kraft) pulping. The black liquor can be from hardwoods, softwoods or grasses. Hardwoods are angiosperms. Exemplary hardwoods can be aspen, ash, alder, basswood, beech, birch, chestnut, cottonwood, elm, eucalyptus, gum, magnolia, maple, poplar and tulip. Softwoods are gymnosperms. Exemplary softwoods are cedar, Douglas fir, fir, hemlock, larch, pine and spruce. Other exemplary pulps are pulps from kenaf and grasses.

There is also a difference in the lignin that is obtained depending on the process used to separate the lignin from the cellulose. Soda pulping, sulfite pulping and sulfate pulping will react differently with the lignin and produce different lignin products. The soda process uses sodium hydroxide as the cooking chemical in the cooking liquor. Sulfite pulping uses sodium, ammonium or magnesium sulfite as the cooking chemical in the cooking liquor. The principal reaction in the sulfite process is the sulfonation of the lignin. The sulfate process uses sodium hydroxide and sodium sulfide as the cooking chemicals in the cooking liquor. These different cooking chemicals will react with the lignin differently.

The purpose of the various pulping processes is to separate the lignin and some of the hemicelluloses from the cellulose. During the cooking process the lignin is solubilized by the cooking chemical and migrates from the wood chip to the cooking liquor. At the end of the pulp cook the spent cooking liquor with its load of organic material, including lignin, which is now called black liquor is separated from the cellulose. Black liquor contains not only lignin but also the hemicellulose sugars. Casey notes that hemicellulose hydrolizes to a variety of saccharide units such as the hexoses-glucose, mannose and galactose; the pentoses-xylose and arabinose; and glucoronic acid and its methylated derivatives.

The lignin must then be separated from the black liquor. The black liquor has a pH of around 13. The lignin is separated from the black liquor by reducing the pH of the black liquor to a pH of 10 or lower. Typical separation pHs are from 10 to 7.5. Sulfuric acid, hydrochloric acid or carbon dioxide are typically used for pH adjustment.

The black liquor can be filtered to remove extraneous material before acid treatment.

Softwood kraft lignin normally has a higher T_{g} than hardwood kraft lignin or lignin extracted by other process such as organosolv, EMAL and milled wood lignin. Lignin has a large molecular weight distribution and its glass transition occurs over a large range. T_{g} is typically measured at ½ the value of ΔCₚ in order to account for the molecular weight distribution. A measurement at the beginning or end of ΔCₚ will give a substantially lower or higher value for T_{g} than when it is measured at ½ the value of ΔCₚ.

Glass transition temperatures for softwood kraft lignin T_{g} have been reported from 169° C. -180° C. There was a report of a T_{g} of 148° C. for a CO₂ precipitated kraft lignin. There was a report of a T_{g} of 124° C. but this was taken at the onset of the ΔCₚ for the transition and provided a low reading for T_{g} as it was not measured at ½ the value of ΔCₚ (Hatakeyama, H., K. Iwashita, G. Meshitsuka and J. Nakano. 1975. Effect of molecular weight on the glass transition temperature of lignin. Mokuzai Gakkaishi. 21(11): 618-623.).

The literature also indicates that the T_{g} of lignin is related to the M_{W} value (weight average molecular weight) of the lignin. There is shown to be a positive correlation between the molecular weight of the lignin polymer and the glass transition temperature.

### BRIEF DESCRIPTION OF THE DRAWING

FIG. 1 is a graph showing T_{g} vs. M_{W} for a number of the inventive lignins.

FIG. 2 is a chart of a Kingstad fractionation of a softwood lignin.

FIG. 3 is a chart of a Kingstad fractionation of one embodiment of the lignin of the present invention.

FIGS. 4-6 are GPC data for representative samples of the lignin of the present invention.

FIGS. 7-8 are DSC curves for representative samples of the lignin of the present invention.

FIG. 9 is a P NMR graph of a comparative lignin embodiment.

FIG. 10 is a P NMR graph of an inventive lignin embodiment.

FIG. 11 is a C NMR graph of a comparative lignin embodiment.

FIG. 12 is a C NMR graph of an inventive lignin embodiment.

### DETAILED DESCRIPTION

The inventor has discovered a softwood kraft lignin that has a low T_{g}. The lignin has an average molecular weight of at least 6,000 daltons and comprises (a) from 2% to 10% of a low molecular component having a weight average molecular weight (M_{W}) of from 300 to 1500 daltons, and (b) from 10% to 50% of a high molecular weight component having a weight average molecular weight (M_{W}) of at least 10,000 daltons; and exhibits a T_{g} of from 100° C. to 130° C. when measured by differential scanning calorimetry.

During heating, 10-50 chain molecules start to move co-ordinately, giving rise to the glass transition temperature (T_{g}). The glassy state is the region where molecules are rubbery, meaning that it is possible to stretch the material and snap it back to its original length. Glass transitions are influenced by the free volume between polymer chains, the freedom of molecular side groups, branches, chain stiffness and chain length among other factors. These properties are influenced by the polarity of the units as well as their covalent bonds.

Without being bound by theory it is believed the amounts and molecular weights of the two fractions cause the T_{g} to be in the range of 100° C. to 130° C. The T_{g} is fairly constant over a wide range of molecular weights (M_{W}) in contrast to reported lignin T_{g} which rise rapidly with a rise in molecular weight.

It should be noted that the there appears to be little difference in the chemical content of the inventive softwood lignin and other softwood lignins as shown by ³¹P NMR spectroscopy and quantitative ¹³C NMR characterization.

For the purposes of this application a softwood lignin from the Backhammar mill in Sweden was used as a comparative lignin.

In this application the following methods were used:

Glass Transition

Glass transitions were measured on a TA Instrument Q200 Digital Scanning calorimeter (DSC) using Aluminum T-Zero Hermetic Pans. 7-10 mg lignin was ground to a fine powder and dried in vacuo at 95° C. with Drierite. The method employed involved cooling the samples at 15.00° C./min from room temperature to −75.00° C., heating at 15.00° C./min to 200.00° C., cooling at 15.00° C./min to -75.00° C., and a final heat at 15.00° C./min to 200.00° C. Glass transitions were observed in the final heat cycle. DSC spectra were obtained at Weyerhaeuser Technology Center.

Measurement of the glass transition (T_{g}) can show a high dependence on variability in the DSC method which is used to collect the data (i.e. heating rate and sample size). Because of this, it is important to maintain consistent sample size and and method for all samples. There are additional factors which can skew DSC results. This includes, but is not limited to, plasticization by residual water or other solvents. For this reason, it's important to fully dry the lignin prior to running DSC. Different analysis methods of the DSC curve can attribute to T_{g} variability. T_{g} is reported as ½ the value of ΔC_{P} for the transition.

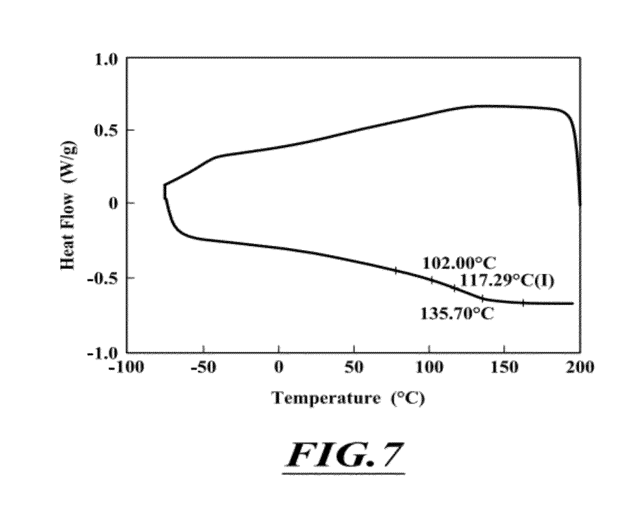

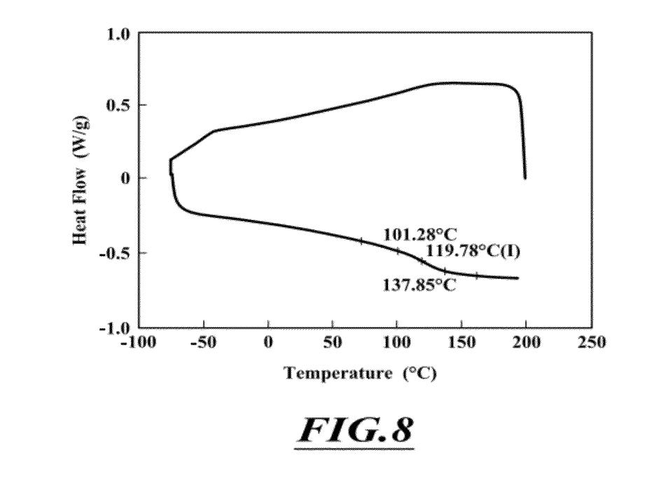

FIGS. 7 and 8 are DSC curves for two embodiments of the inventive lignin. The three temperatures in each of the graphs are, in order, the upper softening point, the glass transition temperature T_{g} and the lower softening point.

Molecular Weight

The lignin samples were acetylated to allow dissolution in tetrahydrofuran (THF) for GPC analysis. The lignin samples (˜100 mg) were stirringly acetylated with 2 mL of acetic anhydride/pyridine (1/1, v/v) at room temperature for 24 hours. After acetylation, the acetylated lignin sample was then dissolved in THF for GPC analysis using Agilent 1200 series liquid chromatography containing ultraviolet (UV) detector. The sample was filtered through a 0.45 μm membrane filter prior to injection. 20 μl of sample was automatically injected. GPC analyses were carried out using a UV detector on a 4-column sequence of Waters™ Styragel columns (HR0.5, HR2, HR4 and HR6) at 1.00 ml/min flow rate. Polystyrene standards were used for calibration. WinGPC Unity software (Version 7.2.1, Polymer Standards Service USA, Inc.) was used to collect data and determine molecular weight profiles. GPC Analysis was performed at the Institute of Paper Science and Technology (IPST).

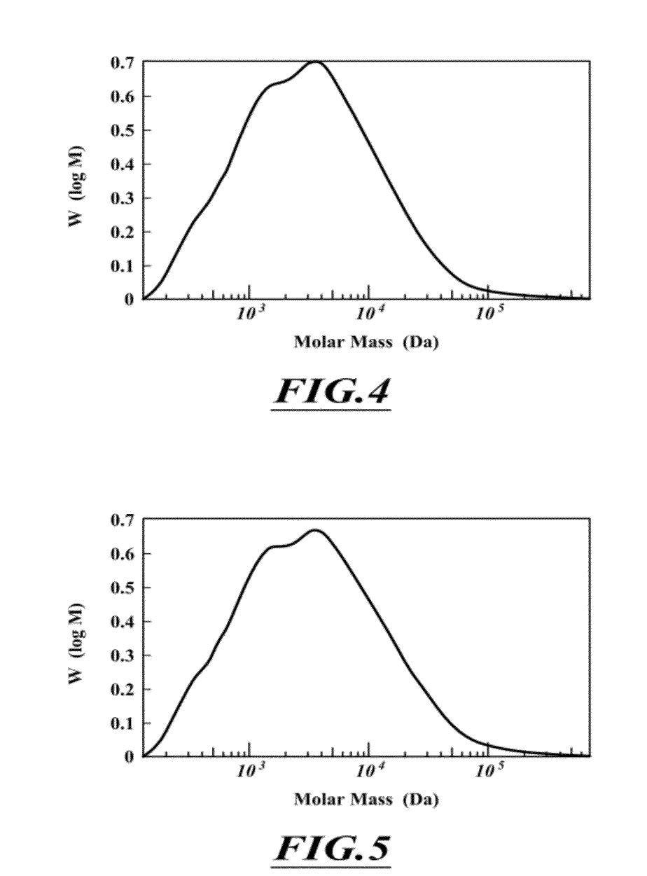

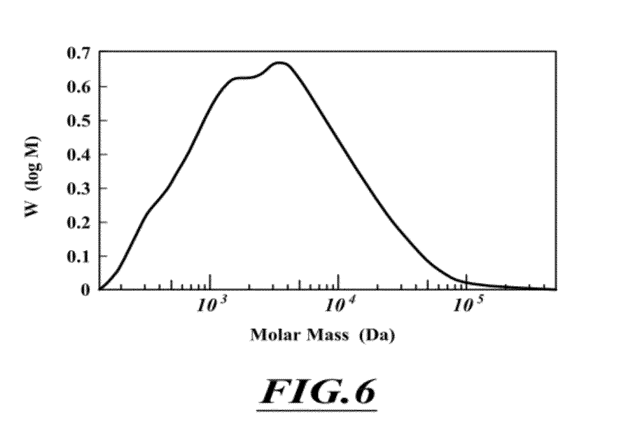

FIGS. 4-6 are GPC curves for three embodiments of the inventive lignin.

Kringstad Solvent Fractionation Technique

500 O.D. grams of water washed lignin was washed sequentially with methylene chloride, n-propanol, methanol and methanol/methylene chloride (7/3, v/v). For each step, the dry lignin was dispersed into 2 liters of solvent while stirring and stirred at room temperature for 30 minutes. The slurry was filtered and the insoluble material was resuspended in an additional 2 liters of solvent and stirred for 30 minutes at room temperature before being filtered again. At this point, the undissolved material was rinsed with an additional 1 liter of solvent. The undissolved material was ground to a fine powder and dried in vacuo at 95° C. in the presence of Drierite. The filtrates were combined and concentrated under reduced under pressure. The resulting solid was ground into a fine powder and dried under the same conditions. This solvent extraction resulted in five different lignin fractions. The molecular weight increases through the fractions, F1 being the lowest molecular weight and F5 being the highest molecular weight.

F1=methylene chloride soluble fraction

F2=n-propanol soluble fraction

F3=methanol soluble fraction

F4=methanol/methylene chloride soluble fraction; 70/30

F5=final undissolved residue

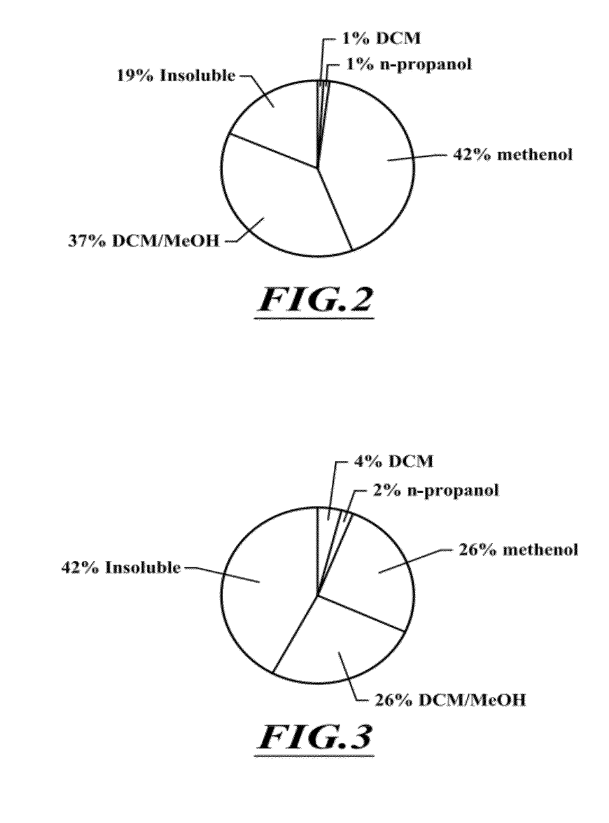

There is a difference in the fractions in a comparative softwood lignin and in the lignin of the present invention as shown by two representative samples. This is shown in FIGS. 2 and 3. The weight percent of the F1 fraction was 1% for the comparative lignin and 4% for the inventive lignin. The weight percent of the F2 fraction was 1% for the comparative lignin and 2% for the inventive lignin. The weight percent of the F3 fraction was 42% for the comparative lignin and 26% for the inventive lignin. The weight percent of the F4 fraction was 37% for the comparative lignin and 26% for the inventive lignin. The weight percent of the F5 fraction was 19% for the comparative lignin and 42% for the inventive lignin. This is a comparison of an embodiment of a comparative softwood lignin and an embodiment of the inventive lignin.

The inventive lignin has a weight average molecular weight (M_{W}) of at least 6,000 daltons and the lignin comprises (a) from 2% to 10% of a low molecular component having a weight average molecular weight (M_{W}) of from 300 to 1500 daltons (the F1 component), and (b) from 10% to 50% of a high molecular weight component having a weight average molecular weight (M_{W}) of at least 10,000 daltons (the F5 component). The F2-F4 fractions comprise the rest of the lignin.

³¹P NMR (Nuclear Magnetic Resonance)

The samples were dried under vacuum for 24 hours at 40 ° C. and accurately weighed out into 2 ml vial (˜20 mg). The ³¹P-NMR spectra of samples were characterized by using a Bruker 400 MHz DMX NMR spectrometer. The dried samples were dissolved in a solvent of pyridine/CDCl₃ (1.5/1 v/v) and phosphorylated with 2-chloro-4,4,5,5-tetramethyl-1,3,2- dioxaphospholane (TMDP). The cyclohexanol served as the internal standard and chromium acetylacetonate as relaxation agent. The spectra were recorded 25s pulse delay, 128 acquisitions at room temperature.

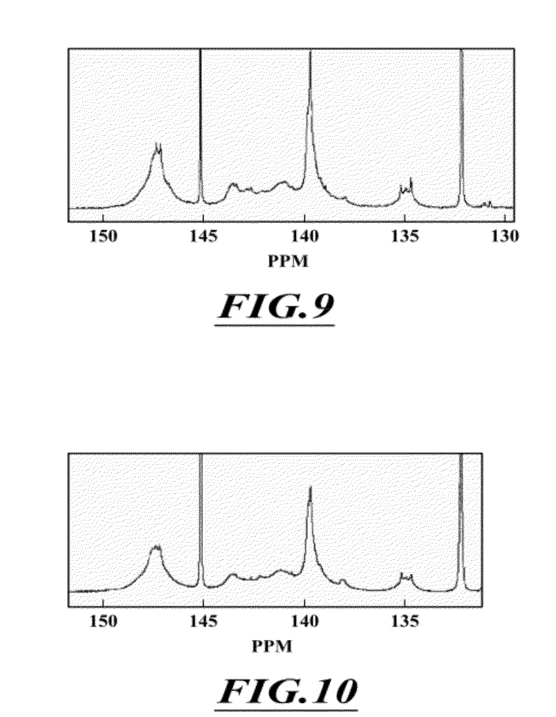

The results are shown in Table 1 and in FIGS. 9-10.

TABLE 1

| | | C-5 | | | |
|---|---|---|---|---|---|
| | | substituted | | | |
| | Aliphatic | Phenolic | Guaiacyl | p- | Carboxylic |
| | OH | OH | OH | hydroxyl | OH |
| | mmol/g | mmol/g | mmol/g | mmol/g | mmol/g |
| | lignin | lignin | lignin | lignin | lignin |
| Compar- | 1.83 | 1.75 | 1.88 | 0.22 | 0.48 |
| ative | | | | | |
| Inventive | 1.89 | 1.70 | 1.91 | 0.25 | 0.43 |

¹³C NMR

The same samples were analyzed using quantitative ¹³C-NMR with a Bruker 400 MHz Avance/DMX NMR spectrometer. The lignin sample (˜0.1 g) was dissolved in DMSO (0.5 ml). The ¹³C-NMR spectrum was recorded under quantitative conditions employing inversed-gated decoupling pulse, a 90° pulse, 12 s pulse delay at 50° C. 12,288 scans were accumulated for each spectrum. The integral between 160-107 ppm was set as the reference, assuming it includes six aromatic carbons. Manual phasing and baseline corrections were carried out before integration.

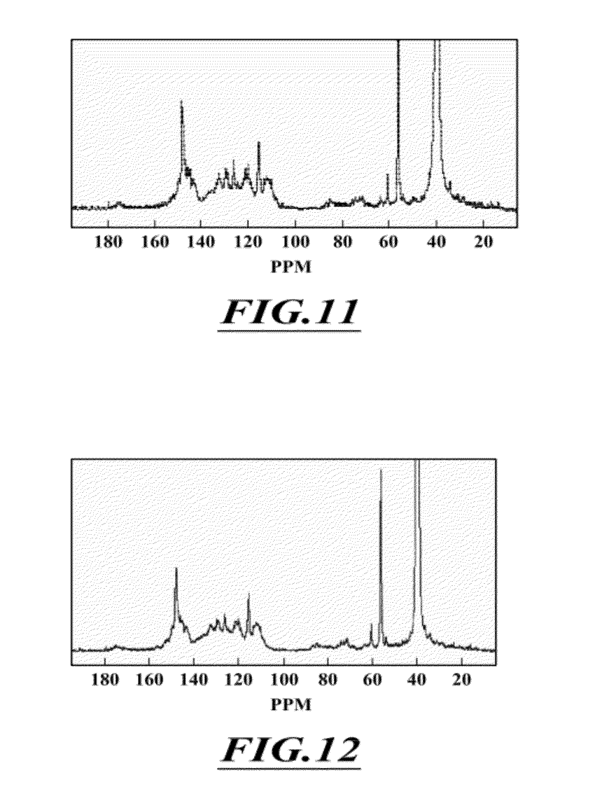

The results are shown in Table 2 and FIGS. 11 and 12.

TABLE 2

| Chemical shift, | | | |
|---|---|---|---|
| ppm | Groups | Comparative | Inventive |
| 160~140 | C_{Ar}—O(oxygenated C) | 2.08 | 2.02 |
| 141~123 | C_{Ar}—C (substituted C) | 1.92 | 1.97 |
| 123~107 | C_{Ar}—H (un-substituted C) | 2.00 | 2.00 |
| 90~78 | C_{β} | 0.25 | 0.26 |
| 78~67 | C_{α} | 0.36 | 0.34 |
| 61.1~58.5 | C_{γ} in β-O-4 without α-C═O | 0.19 | 0.17 |
| 58.0~54.0 | Methoxyl OCH₃ | 0.83 | 0.80 |
| 54.0~52.6 | C_{β} in β-β& β-5 | 0.09 | 0.09 |

NMR results (expressed as per aromatic ring)

The inventive lignin used for the tests was recovered from Southern Pine Kraft black liquor by acidification with CO₂ which resulted in the precipitation of some of the lignin. The lignin was separated via filtration and washed further with acidified water before being filtered and dried. The resulting lignin showed high purity with ash levels less than 0.5%. Chemical analysis was performed using both ³¹P-NMR and quantitative ¹³C-NMR and was shown to be very comparable to another industrial softwood Kraft lignin.

Industrial lignin samples were fractionated according to the Kringstad fractionation method and the M_{W} of the fractions were determined. The T_{g} of the lignin samples was also determined.

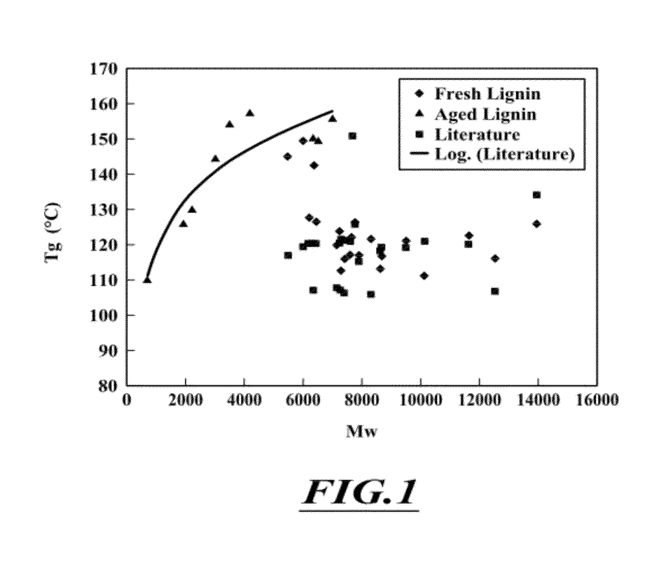

Fresh samples and aged samples of the industrially produced lignins were tested. The results are shown in FIG. 1, which also plots the M_{W} of literature references. It can be seen that the present lignin has a remarkably constant T_{g} over a wide range of molecular weights (M_{W}) in contrast to the literature references which show a rapidly rising T_{g} as the molecular weight increases.

1. A lignin having a weight average molecular weight (M_{W}) of at least 6,000 daltons wherein said lignin comprises
(a) from 2% to 10% of a low molecular component having a weight average molecular weight (M_{W}) of from 300 to 1500 daltons, and
(b) from 10% to 50% of a high molecular weight component having a weight average molecular weight (M_{W}) of at least 10,000 daltons;
wherein the fractions of high and low molecular weight is determined by the Kringstad fractionation process, and
wherein said lignin exhibits a T_{g} of from 100° C. to 130° C. when measured by differential scanning calorimetry.

2. The lignin of claim 1 wherein the T_{g} is from 105° C. to 125° C.
